(19) United States
(12) Patent Application Publication
(10) Pub. No.: US 2012/0181792 A1
(43) Pub. Date: Jul. 19, 2012

(54) Wind turbine

(75) Inventors: Ove Joraas Pettersen, Ranheim (NO); Torolf Pettersen, Ranheim (NO)

(73) Assignee: BLAASTER WIND TECHNOLOGIES AS, Ranheim (NO)

(21) Appl. No.: 13/395,393

(22) PCT Filed: Sep. 10, 2010
(86) PCT No.: PCT/NO2010/000334

§ 371 Date: Mar. 26, 2012

(30) Foreign Application Priority Data
Sep. 11, 2009 (NO) NO20092984

(51) Int. Cl. F03D 9/00

(52) U.S. Cl. 290/55

(57) ABSTRACT

A wind turbine comprising an integrated and segmented permanent magnet generator without the traditional end covers with bearings and shaft making it possible to manufacture and transport generator segments consisting of both generator stator and rotor segments as ready to assemble and already positioned to each other as easy transportable elements to an assembly place where they are integrated with the generator rotor and bearing system of the wind turbine to form a complete wind turbine driveline with blades, hub, bearing unit and an integrated permanent magnet generator with concentric air gap between generator stator and rotor.

The invention relates to wind turnbine with an integrated segmented permanent magnet generator, according to the preamble of claim 1.

### BACKGROUND

The use of wind turbines to produce electricity from wind is one of several methods to utilize renewable energy sources. Wind turbines with a geared transmission between the turbine rotor and the generator have so far been the dominating driveline layout for wind turbines, but with a high risk for mechanical breakdown and unnecessary driveline complexity. In addition a gear based driveline needs extra control and maintenance even if there is no driveline breakdown.

To overcome these challenges a direct drive wind turbine is preferable due to its simpler design with few moving components and high reliability, no risk for gearbox breakdown and lower maintenance budgets compared to geared wind turbines. Using permanent magnets instead of traditionally electromagnets in the rotor of the generator add another simplification to the design.

So far the main challenge has been to construct direct drive wind turbines to the same cost level as for geared wind turbines with comparable power output, and with the same flexibility for road transport and site installation. Especially the manufacturing costs of large direct drive generators and the extra costs for the transportation and their field installation due to the physical size and weight have threatened the use of direct drive wind turbines compared to geared wind turbines when the generators are passing 4-5 meter in diameter and in the multi-megawatt sizes, in spite of their other attractive properties in a lifetime perspective.

Several configurations already exist for direct-drive wind turbines:

US2004041407A to Pettersen & al. describes a solution where a direct drive permanent magnet generator is fixed to the wind turbine shaft where only small external forces from the wind turbine shaft is acting on the generator, except for the varying shaft torque giving no deformation forces around the air gap of the generator. But the generator is a traditional permanent magnet generator with end covers, bearings and shaft, and impractical to transport and install in separate pieces, even if the stator is segmented.

Publication US 2007284959A to Kurronen & al. describes the stator segments, but they are built to be positioned between generator end covers.

Publication No. WO 02/057624 to Wobben is concerning how a double tapered bearing can be fixed to a hollow stationary shaft carrying the blades, hub, and generator rotor and stator with carrier to maintain a constant air gap between the stator and rotor in a traditionally electro magnetized generator. No details regarding segmentation of the turbine is described. Nothing is said about how this can be realized with a permanent magnet rotor technology where rotor and stator segments are already positioned to each other as road transportable and lifting elements to be assembled individually to a bearing system and a stator carrier to form a complete generator.

Publication No. WO 01/21956 to Lagerwey discloses another single-bearing, direct drive wind turbine, but the stator and permanent magnet rotor is not segmented and are road transported into the field as a complete generator with a bearing system in one piece limiting this design in power size.

Publication No. US 2009/0026771 A1 to Bevington & al. describes one way of making a direct drive generator for wind turbines, but says nothing about how the generator can be built up from segments to reduce manufacturing, transport and handling challenges along with how to scale the generator in electrical size and diameter.

European Patent Application EP 2 063 115 A1 to Stiesdahl describes a direct drive wind turbine with a direct drive generator where the outer stator and inner rotor segments preliminary positioned to each other can be transported as generator segments to simplify the transport to an assembly place where the respective stator and rotor segments can be bolted to ring-shaped front and rear stator supporting elements and ring-shaped front and rear rotor supporting elements connecting them to the bearing system before forming a complete driveline with a direct drive generator integrated on a stub shaft.

The driveline has four bearings giving a complicated load distribution on the bearings with possibilities for overloads and shorter lifetime compared to a more classical load cases.

Further, all the deformation forces from the wind turbine rotor and blades give deformation to the whole generator structure and may damage the air gap between the stator and rotor. Under assembly of the complete driveline the stator and rotor segments also have to be adjusted relative to each other in a time-consuming assembly process to give the right air gap between stator and rotor.

A double support construction for both stator and rotor support will also give unnecessary material usage.

To change some of the bearings, the generator need to be taken apart, and there is no access for a person to the hub via the stub shaft to do maintenance on the e.g. the pitch system, the control units and other equipment in the hub.

Object

The main object Of the invention is to provide a wind turbine which overcomes the manufacturing costs, physical size, increased weight and transport challenges associated with directly driven wind turbines compared to geared wind turbines, to achieve their other attractive properties.

It is further an object of the invention to provide a wind turbine which at least reaches the installation costs for geared wind turbines in combination with the much more favourable risk profile and maintenance costs compared to geared wind turbines.

It is an object of the invention to provide a wind turbine which can be transported without the generator to the installation site to save transport costs.

It is further an object of the invention that with rest of the wind turbine in place at site the generator can be connected to the turbine bearing unit to form a complete generator from preassembled and easy transportable stator and rotor segments.

It is further an object of the invention to provide a wind turbine where the generator can be assembled on the bearing unit of the wind turbine with simplified field assembly equipment and without any need for repositioning the air gap between stator and rotor at site after transport and assembly.

It is also an object of the invention to provide a wind turbine where the support structure, bearing unit and generator are easy to mechanically separate for simplified logistics and repair.

It is finally an object of the invention that a complete generator formed by generator segments arranged to a bearing unit can be connected to a wind turbine support structure as a complete unit, and where the stator can be connected to the wind turbine support structure and the wind turbine rotor and blades can be connected directly tote rotating part of the bearing contained in the bearing unit without any shaft.

The Invention

A wind turbine according to the invention is described in claim 1. Advantageous features of the wind turbine are described in claims 2-17.

The invention discloses how to integrate a permanent magnet generator having close to horizontal rotating axis from separately manufactured generator segments consisting of stator and rotor segments locked to each other during assembly and transport, and how to connect the segments to a bearing unit to form a complete generator with bearings to be arranged to a support structure of a wind turbine and without any need for repositioning the air gap between the rotor and stator of the generator after final assembly. The generator is formed by generator stator and rotor segments. The generator stator segments preferably include a cantilevered, stator housing which is adapted to be arranged to the periphery of the bearing unit. Inside the cantilevered stator housing different solutions tor the stator windings divided into segments can be arranged. The rotor segments preferably include magnet supports for the fixation of magnets. The rotor segments with magnets in place are positioned with special tools to the right air gap relative to the stator windings inside each generator stator segment and the generator stator segments and generator rotor segments are locked relative to each other by a preliminary locking system. Assembled together around the periphery of the bearing unit these separate generator segments form a complete ring generator with a generator rotor rotating with the right air gap inside-or outside the cantilevered generator stator depending on the chosen configuration of bearing unit. This makes it possible to assemble the entire generator before it is fixed to the wind turbine support structure and to a wind turbine rotor.

The invention also includes a combined inching, braking and locking device to control the rotational movement between the rotor and stator of the generator. The combination device makes it also possible to exactly position the wind turbine rotor in any position to the stator when in great unbalance such as under individual blade installation, and makes it possible to exactly position the generator rotor in any position for inspection and maintenance.

Further advantages and preferable features of the invention will appear from the following example description.

### EXAMPLE

The invention will now be described in detail with references to the attached drawings, where:

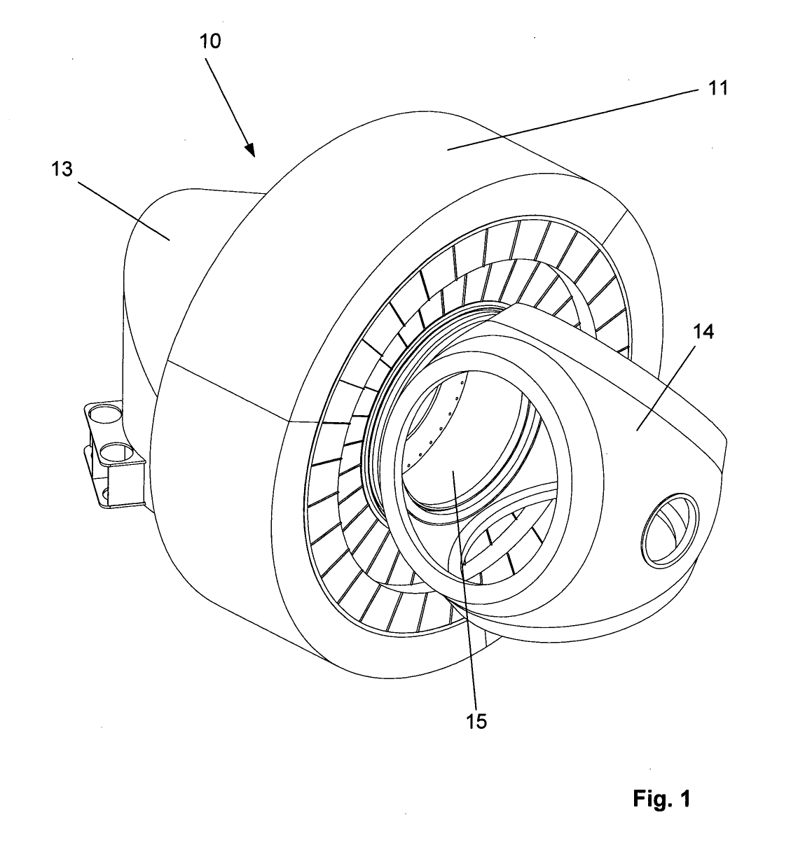

FIG. 1 shows a complete generator fixed to a wind turbine support structure, while a wind turbine rotor is fixed to a rotating part of a bearing contained in a bearing unit,

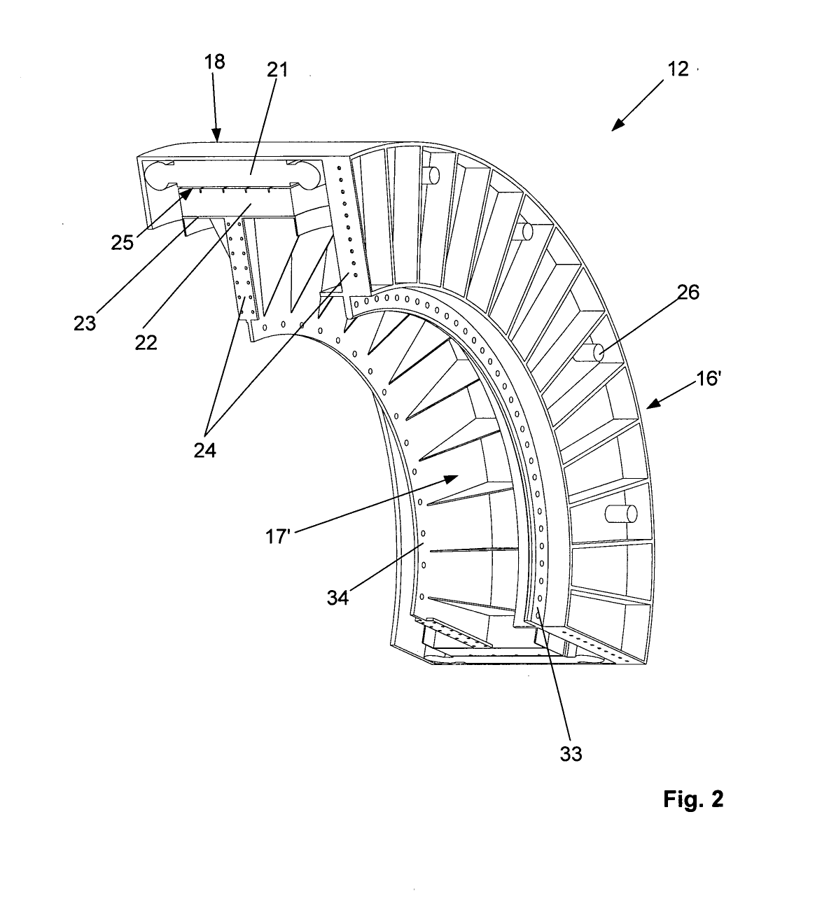

FIG. 2 shows a typical generator segment with generator stator and rotor exactly positioned to each other before assembly to a complete generator,

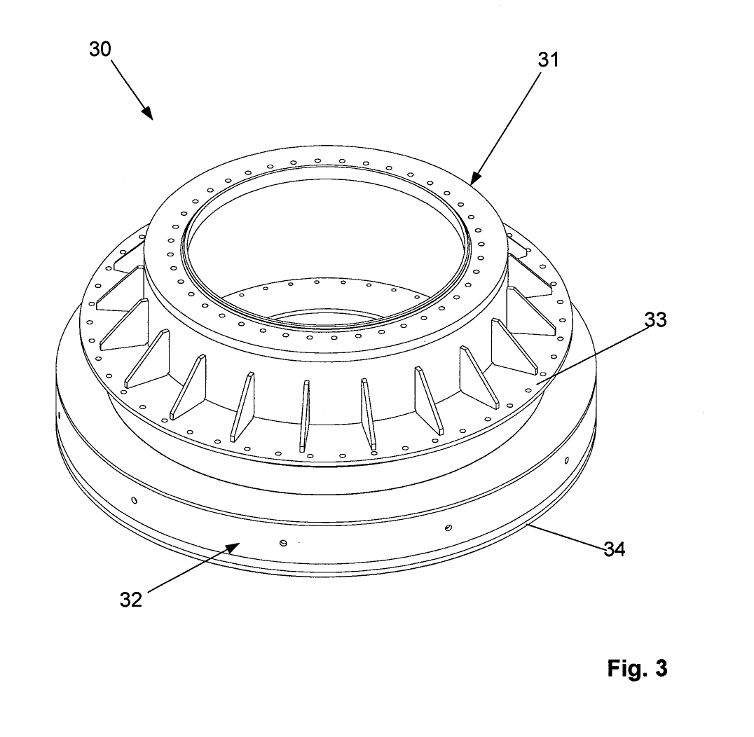

FIG. 3 shows a perspective view of a wind turbine bearing unit,

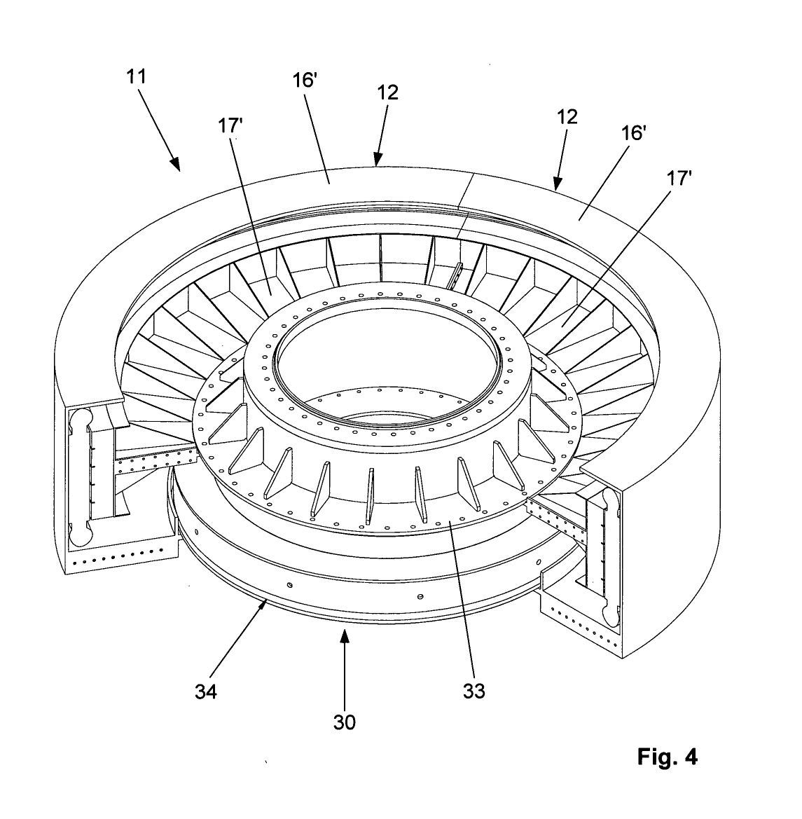

FIG. 4 shows how the generator stator and rotor segments are assembled to the bearing unit before the completion of the generator on the bearing unit to later to be fixed to a wind turbine support structure on top of a tower,

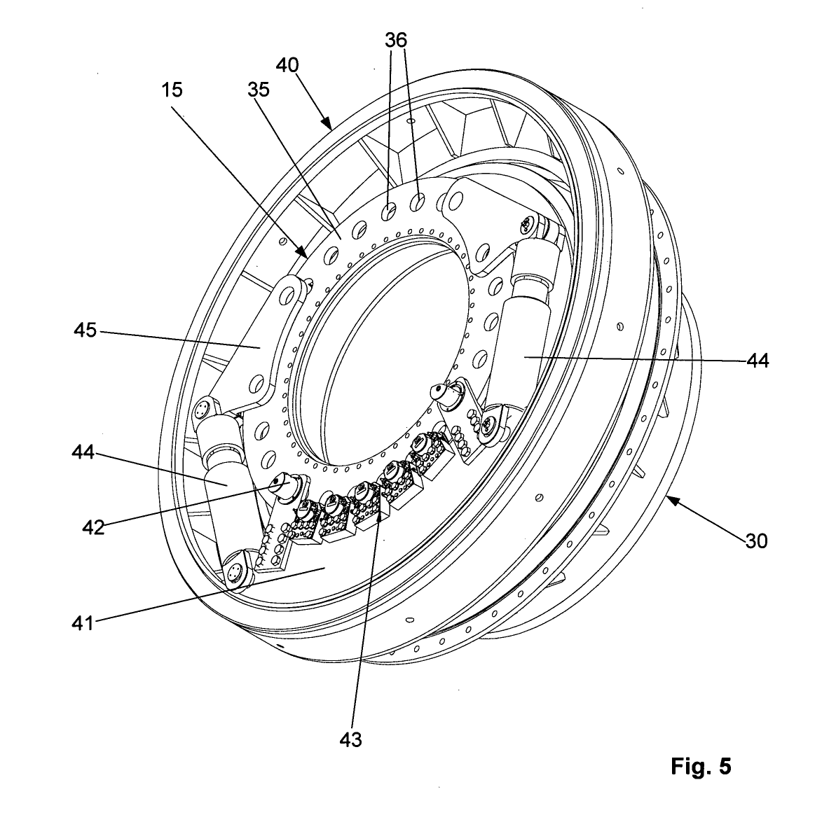

FIG. 5 shows a device for inching, braking and locking the rotor, and

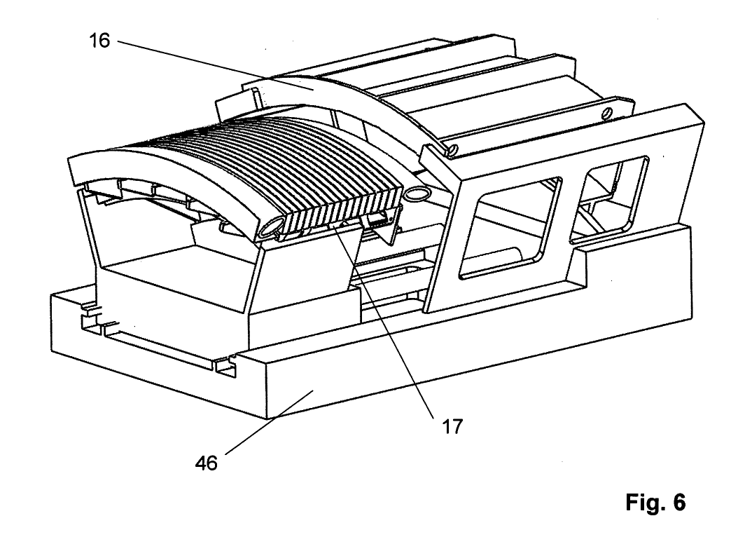

FIG. 6 shows an example of a hydraulic jig for positioning a stator segment into a rotor segment.

Reference is now made to FIG. 1 which shows an upper part of a wind turbine 10 according to the invention, where a generator 11 is built up by generator segments 12 (see FIGS. 2 and 4), connected to a bearing unit 30 (see FIG. 3) containing a bearing arrangement. The bearing unit (30) itself is carried by a support structure 13. Further, a wind turbine rotor 14 is connected to rotating part 32 of a bearing carried by the bearing unit (30). No wind turbine blades are shown arranged to wind turbine rotor 14 to provide a better view of the invention. The tower is neither shown, as this can be realized in different ways, such as steel tubular tower, concrete tower, lattice tower, or combination of these.

Reference is now made to FIG. 2 which shows a perspective view of a generator segment 12 of a generator 11 containing both generator stator 16′ (hereinafter called stator) and rotor 17′ (hereinafter called rotor) segments of the generator 11. The stator 16′ segments are assembled to form a complete generator stator 16 and the rotor 17′ segments are assembled to form a complete generator rotor 17. The stator segments 16′ preferably include a cantilevered stator housing 18 at the outer periphery. The stator segments 16′ are further at the inner periphery provided with a flange 19, via which the stator segments W are connected to a static part 32 of the, bearing unit 30. The rotor segments 17′ are provided with a flange 20 for connection to the rotating part 31 of the bearing in the bearing unit 30 together with the wind turbine rotor 14. The generator 11 can based on the main principals of the present invention also be realised with the generator rotor 17 placed outside of the stator 16 forming e generator with the outer periphery rotating.

As mentioned the stator segments 16′ includes a stator housing 18 which is such designed that different winding solutions 21 can be chosen and fixed to the stator segments 16′.

The same apply to the outer periphery of the rotor segments 17′ where different fixations of permanent magnets 22 may be applied by means of magnet supports 23. The stator housing 18, stator windings 21, as well as the magnets 22 and magnet supports 23 may be segmented in an appropriate number depending of generator size and practical ways for manufacturing, transport and assembly to form one complete generator.

The exterior of the stator housing 18 can be provided with different cooling solutions for the stator winding, i.e. cooling ribs for direct air cooling, water jacket for combination with water to air heat exchangers, special shrouds for increased air circulation around the cooling ribs with the help of fans or similar.

In addition to being fixed to the static 32 and rotating parts 31 of the bearing unit 30 at flanges 33 and 34, both the stator 16′ and rotor 17′ segments are fixed, for example by bolting, individually to each other at the ends 24. The connections should be carried out in a way that the needed tolerances of the construction can be adapted.

The radial position of an air gap 25 and the width of the same air gap 25 may vary depending of the electrical size of the generator 11 and the rpm rating. The same apply to the diameters of the flanges 33 and 34 that may vary depending on the size of the generator 11 and the bearing solution of the wind turbine 10.

The rotor segments 17′ with permanent magnets 22 installed are positioned into the stator segments 16′ during fabrication and kept in position to each other with a positioning and locking device 26 until both the stator 16′ and rotor 17′ segments, are integrated to a complete generator 11 on the bearing unit 30 by means of an assembly tool.

The rotor segments 17′ can be manufactured and assembled in a way such that sufficient tolerances for the air-gap 25 are achieved from the manufacturing process itself for positioning of the rotor and stator flange relatively to each other. This can be carried out using, for instance, a hydraulic tool where the rotor is put into the stator, or the other way around, either radially, axially or rotationally. Another option is to place the rotor and stator together using temporary brackets that allow adjustment of the segments relatively to each other after assembly to get the right air-gap. FIG. 6 shows an example of a hydraulic jig 46 made for adding the stator segment 17 into the rotor segment 16, axially and positioned with high tolerances in the configuration with an outer rotor and an inner stator.

Reference is now made to FIG. 3 which shows a perspective view of the wind turbine bearing unit 30 which can involve several types of bearings inside.

To assemble the generator segments 12 to a complete generator 11, the segments 12 are attached to the bearing unit 30 at the flange 33 for the stator segments 16′ in this configuration, and at flange 34 for the rotor segments 17′. The segments 12 can either be moved into position radially or axially on the bearing unit 30. The bearing can be a double row tapered bearing, different types of conical bearings or slide bearings. The bearing is installed in the bearing unit 30 in a controlled environment with the right positioning between stationary and rotating parts, where only the fixation of the stator and the rotor part of the generator to the bearing unit 30 is left for field assembly at the flanges 33 and 34 to form a complete generator with bearing.

Reference is now made to FIG. 4 which shows the generator 11 when one stator 16′ and rotor 17′ segment are still missing on the bearing unit 30. The number of both stator 16′ and rotor 17′ segments may vary in numbers from two or more depending on manufacturing and electrotechnical considerations.

After the integration of the complete generator 11 to the bearing unit 30, the stator 16 to rotor 17 positioning and locking device 26 can be removed, and the generator rotor 17 is free to rotate inside the generator stator 16, and to be lifted in one piece; for fixation to the wind turbine support structure 13 without any specific tolerance needed for positioning to the wind turbine support structure to maintain the right air gap 25.

Reference is now made to FIG. 5 which shows a device 40 for inching, braking and locking of the wind turbine rotor 14 for different purposes. The device 40 is adapted to be arranged between the bearing unit 30 and the wind turbine rotor 14. The device 40 includes a support bracket 41, to which locking pins 42 and brake callipers 43 are arranged. The device 40 also includes one or more inching cylinders 44, in the shown example two, which are supported by the support bracket 41 in one end. To the free moving end of the inching cylinders 44 is arranged a connecting piece 45. The wind turbine rotor 14 is provided with a flange 35 provided with holes 36 for the locking pins 41 of the device 40 for normal parking in addition to be a brake disc for the brake callipers 43.

The connecting piece 45 of the inching cylinders 44 are provided with, holes and a separate set of locking pins (not shown). The free moving end of the cylinders 44 are connected to the locking holes 36 of the wind turbine rotor 14 by the holes and set of locking pins of the connecting piece 45. When these parts are aligned, the wind turbine rotor 14 is brought to standstill and the brakes are engaged. Engagement of the locking pins of connecting piece 45 can be either manual or automatic.

The cylinders 44 have two functions. One function is to lock one or both cylinders 44 to the wind turbine rotor 14 under severe weather conditions or wind turbine rotor inspections in addition to the locking pins 42. The other function is when inching the wind turbine rotor 14 under for instance installation of each wind turbine blade individually or in connection with maintenance on all rotating parts. With the normal locking pins 42 not engaged, one cylinder 44 can keep the wind turbine rotor 14 in position, while the other cylinder 44 is positioned to take over the circumferential movement of the wind turbine rotor 14 when the first cylinder 44 has reached its outmost position.

The complete wind turbine can be installed in a variation of ways. One method is to install it in five steps; First installation of a tower, then installation of the support structure on top of the tower, then installation of the generator inclusive the bearing unit to the support structure, then installation of the rotor, then individual installation of the blades. The blades can either be installed by a crane, where the blades are installed horizontally Or by a winching system where the blades are Installed vertically.

Modifications

Generators of different electrical sizes and rpm can be integrated with the same generator segment method with just varying air gap diameters and lengths and flange diameters for assembly to the bearing unit in different sizes.

The invention can also be used for generators not equipped with permanent magnets, but by other means for generating electric current.

In the bearing unit shown in the example several types Of bearings can also be used, for instance a double row tapered bearing, hydrostatic or hydrodynamic bearing, double conical bearings, or two roller bearings where one of them can take full thrust force from the wind turbine rotor.

The magnet support of the rotor segments can be adapted to give the possibility to use different permanent magnet installation methods.

The stator housing can support stator lamination and stator windings of different shapes and electrical properties, and with different redundancy strategies.

An inching system where either the inching can be carried out by linear electric motors or by electric inching by the generator itself.

An inching system placed on a larger diameter so fewer brakes can be used.

An inching system where brakes, inching cinders and locks are separated to three different systems.

A cooling solution for the generator where forced air cooling by fans inside a circumferential shroud is used instead of free air flow over the turbine cooling fins.

A cooling solution using either a water jacket outside the stator structure or by an air/liquid heat exchanger, where the, generator is cooled by circulating air inside the generator.

Assembly of the generator segments where the segments can be assembled radially or axially; to the bearing unit using regular cranes or other lifting methods or by using a custom made jig for the operation.

The bearing unit, the generator segments and the hub itself can be made with different material solutions, for instance welded steel, casted steel, forged steel, or by other material such as fibre glass or other fibre resins.

Installation of the turbine where the turbine is assembled from the main components on ground and lifted by crane as a whole unit.

Installation of the turbine on a sliding lift on the tower, far instance on a concrete tower.

The stator can be double supported with an extra support bearing connecting an end cover on the generator with the rotating part 14. By this, neither the rotor nor the stator will be cantilevered.

The generator may have the rotor outside or inside the stator, also changing which of the components that are cantilevered.

The generator stator can be connected directly to the support structure, while the static part of the bearing unit can be connected to the generator stator, or vice versa.

The generator is equipped with a retaining device, for instance made of bronze or other low friction material to avoid that excessive deformations in the generator air-gap are not harming the generator itself.

1. A wind turbine comprising a directly driven permanent magnet generator (11) comprising a generator stator (16) and a generator rotor (17), a wind turbine rotor (14) with blades, and a wind turbine support structure (13) arranged at the top of a tower, wherein the permanent magnet generator is built up from generator segments (12) consisting of preassembled and internally locked (26) stator (16′) and rotor segments (17′) with fixed air gap where the stator segments (16′) are arranged to a stationary part (32) of a bearing unit (30), while the rotor segments (17′) and the wind turbine rotor (14) with blades are arranged to a rotating part (31) of the bearing unit (30).

2. A wind turbine according to claim 1, wherein the bearing unit (30) with the permanent magnet generator (11), the wind turbine rotor (14) and the blades are arranged to the support structure (13) to carry the complete generator (11), bearing unit (30) and the wind turbine rotor (14) with the blades,

3. A wind turbine according to claim 1, wherein the generator stator segments (16′) are provided with a flange (33) at the inner periphery, via which the generator stator segments (16′) are arranged to the bearing unit (30) and the generator rotor segments (17′) are provided with a flange (34), via which the wind turbine rotor (14) is arranged to the generator rotor (17).

4. A wind turbine according to claim 1, wherein the generator segments (12) are provided with a removable positioning and locking device (26) to hold the air-gap in exact position during transportation and installation.

5. A wind turbine according to claim 1, wherein the generator segments (12) are mounted in a controlled environment with a rigid mounting tool (46) to let the stator segment (17′) and rotor segment (16′) be positioned correctly relative to each other and locked with a locking device (26) before the generator segments (12) are mounted on the bearing unit (30).

6. A wind turbine according to claim 1, wherein the generator stator segments (16′) and rotor segments (17′), respectively, are provided with fastening means (24) at the ends for connection to adjacent generator stator (16′) and rotor (17′) segments, respectively to keep a fixed air gap during operation of the complete generator (11).

7. A wind turbine according to claim 1, wherein the generator segments (12), comprising generator stator (16′) and rotor (17′) segments are attached separately to the bearing unit (30) before they can form a complete generator stator (16) and rotor (17) of the permanent magnet generator (11).

8. A wind turbine according to claim 1, wherein the generator stator (16)/stator segments (16′) includes a cantilevered stator housing (18) at the outer periphery which is such designed that different stator winding solutions (21) can be attached to or integrated in the generator stator (16)/stator segments (16′).

9. A wind turbine according to claim 8, wherein the cantilevered stator housing (18) is provided with means for outside cooling of the stator windings (21), such as cooling ribs for direct air cooling, water jacket for combination with water to air heat exchangers or special shrouds for increased air circulation around the cooling ribs with the help of fans.

10. A wind turbine according to claim 1, wherein the generator rotor (17′) segments are provided magnet supports (23) at the outer periphery for the arrangement of permanent magnets (22).

11. A wind turbine according to claim 1, wherein the stator housing (18), stator windings (21) as well as the magnets (22) and magnet supports (23) are segmented in an appropriate number depending of generator size and practical ways for manufacturing, transport and assembly to form one complete generator.

12. A wind turbine according to claim 1, wherein the wind turbine includes a device (40) for inching, braking and locking of the wind turbine rotor (15), which device (40) is adapted for being arranged between the bearing unit (30) and the wind turbine rotor (15), which device (40) is arranged to:
exactly position the wind turbine rotor (15) in any position when in great unbalance, such as under individual blade installation, and
exactly position the generator rotor (16) in any position for inspection and maintenance.

13. A wind turbine according to claim 12, wherein the device (40) includes a support bracket (41), to which support bracket (41) locking pins (42) and brake calipers (43) are arranged, which device (40) also includes one or more inching cylinders (44) which are supported by the support bracket (41) in one end and a connecting piece (45) is arranged to the free moving end of the inching cylinders (44), which connecting piece (45.) is provided with holes and a separate set of locking pins.

14. A wind turbine according to claim 1, wherein the wind turbine rotor (15) is provided with a flange (35) provided with holes (36) for the locking pins (41) of the device (40) for normal parking in addition to be a brake disc for the brake calipers (43).

15. A wind turbine according to claim 1, wherein the bearing unit (16), permanent magnet generator (11) and possibly the device (40) for inching, braking and locking of the wind turbine rotor (15) are arranged to the wind turbine support (13) as one unit, without any further need to control or adjust the air gap (25) of the generator (11).

16. A wind turbine according to claim 1, wherein the bearing unit (30) is manufactured independently from the generator (11); and by assembling the generator segments (12) to the bearing unit (30), the air-gap (25) position is already maintained.

17. A wind turbine according to claim 1, wherein the main turbine components are manufactured independently of each other and can be assembled to a complete wind turbine by simple connections in various ways,

18. A wind turbine according to claim 13, wherein the wind turbine rotor (15) is provided with a flange (35) provided with holes (36) for the locking pins (41) of the device (40) for normal parking in addition to be a brake disc for the brake calipers (43).
